(19) United States
(12) Patent Application Publication
(10) Pub. No.: US 2024/0381518 A1
(43) Pub. Date: Nov. 14, 2024

(54) NOZZLE FOR PLASMA TORCH AND PLASMA TORCH

(71) Applicant: Thermacut, k.s., Uherske Hradiste (CZ)

(72) Inventors: Radim Hunka, Uherske Hradiste (CZ); Petr Vesely, Uherske Hradiste (CZ); Tomas Kusak, Polesovice (CZ)

(21) Appl. No.: 18/689,916

(22) PCT Filed: Sep. 23, 2022
(86) PCT No.: PCT/CZ2022/050098

§ 371 Date: Mar. 7, 2024

(30) Foreign Application Priority Data
Sep. 24, 2021 (CZ) PV 2021-453

(51) Int. Cl. H05H 1/28

(52) U.S. Cl. CPC H05H 1/28

(57) ABSTRACT

Nozzle for a plasma torch, said nozzle comprising: —an internal component (37, 137) which defines an internal pass-through cavity to form a plasma chamber having an outlet opening (7, 107), —an external component (38, 138) which at least partially and coaxially surrounds the internal component (37, 137) and which has a distal conical region, a proximal cylindrical region and an intermediary region (8, 108) between those, wherein radial protrusions (29, 129) are arranged with a mutual angular spacing at an external surface of the external component (38, 138) along a common radial plane between the intermediary region (8, 108) and the proximal cylindrical region.

### FIELD OF ART

The present invention relates to a nozzle for use in a plasma troch suitable for cutting and welding e.g. of metallic materials. The invention also relates to a plasma torch comprising such a nozzle.

### BACKGROUND ART

Nozzles for plasma torches known in the art are made up by two pieces or a single piece and contain a body, which has a surface at its proximal side, the surface being intended for abutting an internal component of the torch, and a distal side comprising a central opening for plasma arc outlet, wherein the nozzle delimits a cavity for housing an electrode between the distal side and the proximal side.

Given the high temperature of the plasma arc which is transferred to the individual parts of the plasma torch, cooling of these parts is necessary. Surfaces of the nozzle are cooled particularly by cooling liquid and additionally by plasma gas and shield gas which simultaneously shields the plasma gas during and after its exit from the nozzle, or the plasma torch.

The document EP3305037B1 e. g. describes a plasma arc torch, the nozzle of which consist of an internal and an external component, wherein a bearing flange is arranged at the internal component of the nozzle for delimiting axial position of the nozzle in the plasma torch. Thus, correct position of the external component must be secured by additional measures. As a result, assembling of the torch is rather time consuming. Likewise, an incorrect positioning of the outer and/or inner part of the nozzle may cause damage of the nozzle due to insufficient cooling or by the plasma arc, when the plasma torch is being used.

The aim of the invention is to prepare a two-piece nozzle structure, which may be reliably positioned within a torch by positioning the external component of the nozzle, wherein cooling of required areas of the nozzle is ensured.

### SUMMARY OF THE INVENTION

An especially intense cooling may be obtained according to the invention for a nozzle for a plasma torch, said nozzle comprising:
an internal component which defines an internal pass-through cavity to form a plasma chamber having an outlet opening,
an external component which at least partially and coaxially surrounds the internal component and which has a distal conical region, a proximal cylindrical region and an intermediary region between those,
   wherein radial protrusions are arranged with a mutual angular spacing at an external surface of the external component along a common radial plane between the intermediary region and the proximal cylindrical region.

Preferably, in an area where the radial protrusions are adjacent to the proximal cylindrical region, the proximal cylindrical region of the external component has a larger diameter than the intermediary part in the area adjacent to the radial protrusions.

Preferably, the radial protrusions overreach in the radial direction the other parts of the nozzle, which means that their maximum distance from the axis of the nozzle is greater than maximum distance of any other part of the nozzle from the axis of the nozzle.

In a preferred embodiment, the radial protrusions have proximal radial surfaces which are arranged in a common radial plain and/or have distal radial surfaces which are arranged in a common radial plane.

Also preferably,
the external surface of the external component is, between the distal conical region and the intermediary region, provided with a first annular groove for a first sealing ring and/or
the proximal cylindrical region of the external component is provided with a second annular groove for a second sealing ring.

In an embodiment intended for higher electric current values, the internal surface of the external component abuts on the external surface of the internal component via a second sealer ring, wherein the external component is, in the intermediary region, provided with a coolant inlet in the form of a through slot or a pass-through opening or openings, and a coolant outlet in the form of a through slot or a pass-through opening or openings for feeding and leading away of the coolant to and from the space between the internal component and the external component.

In an embodiment intended for lower electric current values, a vent space is located between the external surface of the internal component and the internal surface of the external component, wherein the inlet of said vent space is defined between the internal surface of the external component and the external surface of the distal end of the internal component and the outlet is formed by a pass-through vent opening in the wall of the external component.

An intense cooling may be achieved in a plasma arc torch,
a torch body,
an electrode, attached to the torch body,
a nozzle which coaxially surrounds a distal end of the electrode and which is the above described nozzle,
a cap which coaxially surrounds a distal end of the nozzle,
a guiding part, which coaxially surrounds a part of the torch body and a part of the nozzle, and
a directing component, which coaxially surrounds the guiding part, wherein channels for cooling liquid and channels for shield gas are arranged in its distal conical portion.

Preferably, the radial protrusions are held between a distal end surface of the torch body and the internal surface of the guiding part and/or directing component.

Preferably, the spaces between the radial protrusions on the external surface of the external component form passages for feeding of the cooling liquid into the coolant inlet in the intermediary region, or the spaces between the radial protrusions on the external surface of the external component form passages for feeding of the cooling liquid onto the intermediary region.

### BRIEF DESCRIPTION OF THE DRAWINGS

The invention is further described based on exemplifying embodiments which are illustrated in drawings, wherein

FIG. 1 is a perspective view of a nozzle according to a first embodiment,

FIG. 2 is a sectional view of the nozzle of FIG. 1,

FIG. 3 is a perspective view of a nozzle according to a second embodiment,

FIG. 4 is a sectional view of the nozzle of FIG. 3 and

FIG. 5 is a sectional view of a torch and nozzle assembly of FIG. 1.

### DESCRIPTION OF EXEMPLIFYING EMBODIMENTS

A first embodiment of the nozzle according to the invention comprises an external component 38 and an internal component 37, wherein the external component 38 almost entirely surrounds the internal component 37. The internal component 37 and the external component 38 are mutually coaxial along the axis 10, wherein the internal component 37 delimits a cavity for housing of an electrode 35 and for a plasma chamber.

The internal component 37 has a distal end provided with a first outlet opening 7 for outlet of an arc and plasma gas. The distal end of the external component 38 is provided with an opening, the internal walls of which are seated against the external wall of the internal component 37 via a second sealer ring 37b.

A cooling space for cooling liquid is arranged between the internal surface of the external component 38 and the external surface of the internal component 37, and has a coolant inlet 27 in the form of a through slot in the wall of the external component 38, and a coolant outlet 28 having a form of a through slot which is arranged closer to the distal end of the internal component 37 than the coolant inlet 27 and its center is arranged at least 90°, preferably from 140° to 180° angularly spaced from the center of the coolant inlet 27 (about the axis 10).

The distal part of external surface of the external component 38 widens conically from the distal end towards the proximal end. An intermediary region 8 is arranged between the conically widening region and a proximal region of the external surface of the external component 38, and the coolant inlet 27 and the coolant outlet 28 are arranged in the intermediary region 8.

A cylindrical region comprising a first annular groove 3 housing a first sealing ring 21 is arranged between the widening distal region of the external component 38 and the coolant outlet 28.

The external surface of the proximal region of the external component 38 of the nozzle is cylindrical and it comprises a second annular groove 4 housing a second sealing ring 22, and a third annular groove 5 housing a third sealing ring 23.

A shoulder is formed at the interface between said proximal cylindrical region of the external component 38 and the intermediary region 8, wherein a set of radial protrusions 29 is arranged adjacent to said shoulder, wherein the distal surface of said protrusions extends in a plane perpendicular to the axis 10 and the proximal surface extends in a plane perpendicular to the axis 10 as well.

Passages 26 for feeding of the coolant to the coolant inlet 27 are thus delimited between the neighboring radial protrusions 29 and the distal surface of said proximal cylindrical region of the external component 38, the passages 26 being intended for feeding the coolant medium to the coolant inlet 27.

The radial protrusions 29 overreach the inner diameter of both the intermediary region 8 and the cylindrical region of the external component 38.

The external surface of the proximal end of the internal component 37 is provided with an additional groove 211 having an annular shape, wherein an additional sealing ring 212 is arranged in said additional groove 211, wherein said additional sealing ring 212 ensures a sealing of the contact between the internal component 37 and the external component 38 in the proximal end region of the internal component 37, thereby sealing the cooling space on its proximal side.

The first embodiment of the nozzle is particularly suitable for use in a torch designed for operation with a current value exceeding 200 A.

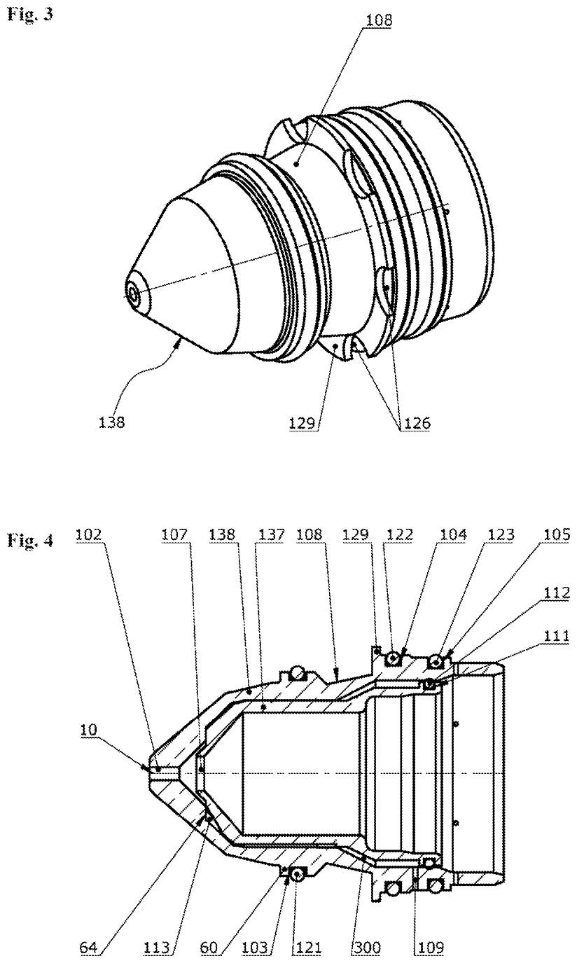

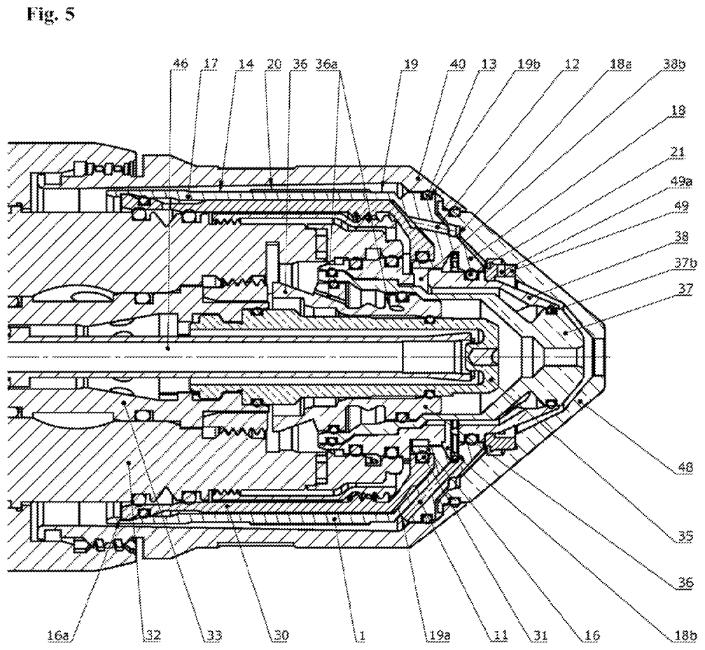

In the second embodiment, illustrated in FIGS. 3 and 4, the nozzle in accordance with the present invention comprises an external component 138 and an internal component 137, wherein the external component 138 entirely surrounds the internal component 137. The internal and the external components 137, 138 are mutually coaxial along the axis 10.

The internal component 137 has a distal end provided with a first outlet opening 107 and the external component 138 has a distal end provided with a second outlet opening 102. The diameter of the first outlet opening 107 is larger than the diameter of the second outlet opening 102.

A vent space 300 is disposed between the internal surface of the external component 138 and the external surface of the internal component 137, wherein the inlet of the vent space 300 is delimited between the external surface of the distal end of the internal component 137 and the internal surface of the external component 138, said inlet being interconnected with a vent opening 109 in the external component 138.

The internal surface of the external component 138 conically widens (its diameter increases) in the direction from the second outlet opening 102, and a following region contains an annular rib 60 protruding from the external surface and comprising a first annular groove 103 housing a first sealing ring 121.

A proximal cylindrical region of the external surface of the external component 138 is provided with a second annular groove 104 housing a second sealing ring 122, and a third annular groove 105 housing a third sealing ring 123.

A shoulder is formed on the distal side of the proximal region of the external component 138, wherein radial protrusions 129 are provided adjacent to said shoulder, the distal surface of said radial protrusions 129 being arranged in a plane, perpendicular to the axis 10, the proximal surface also being arranged in a plane perpendicular to the axis 10.

An intermediary region 108 is disposed between the proximal cylindrical region of the external component 138, in other words between the first annular groove 103 and the second annular groove 104.

Distance of the end surfaces of the radial protrusion 129 from the axis 10 is larger than the diameter of the proximal cylindrical region in areas where said proximal region is adjacent to the radial protrusions 129, and larger than the radius of the intermediary region 108 in areas where said intermediary region 108 is adjacent to the radial protrusions 129. Passages 126 for feeding of the coolant medium to the intermediary region 108 are thus delimited between mutually neighboring radial protrusions 129 and a distal surface of the cylindrical region of the external component 138.

In the intermediary region 108, the external surface at first conically tapers and then conically widens when considered in the direction from the distal end to the proximal end, thereby forming a V-shaped recess. The vertical angle of the distal conical portion of the intermediary region 108 is preferably from 90° to 160°. In this embodiment, the vertical angle equals 90°, the distal conical portion thereby having an inclination of 45° with respect to the axis 10. The vertical angle of the proximal conical portion of the intermediary region 108 is preferably from 20° to 90°. In this embodiment, the vertical angle equals 24°, the proximal conical portion thereby having an inclination of 12° with respect to the axis 10.

The ratio of the length of the intermediary region 108, measured in the direction parallel to the axis 10, to the depth of the recess (in other words to the margin between the largest and the smallest radius of the intermediary region 108), equals 2.5:1 to 5:1.

At the proximal end, the external surface of the internal component 137 is provided with an additional groove 111 having an annular shape, said additional groove 111 housing an additional sealing ring 112 which ensures a sealing of the contact between the internal component 137 and the external component 138 in the region of the proximal end of the internal component 137, thereby sealing the vent space on its proximal side.

The internal surface of the external component 138 conically widens from its outlet opening 102 to the internal radial shoulder 64, from which it also conically widens. The internal component 137 is seated on the radial shoulder 64 via distal surfaces of longitudinal ribs 113 of the internal component, wherein said longitudinal ribs 113 protrude from its external distal conical surface. The second embodiment of the nozzle is particularly preferable for use in a torch intended for operation under currents of 30 A to 220 A, most preferably 170 A.

When assembled, the torch assembly with the nozzle (of embodiments 1 and 2) comprises a torch body 32 with an electrode 35 fixed to it via a cathode 33 In the illustrated embodiment, the electrode 35 is hollow and a cooling tube 46 is arranged inside the electrode 35 for delimiting trajectory of the cooling liquid for cooling the electrode 35 at its internal side. A portion of the side walls of the electrode 35 surround a swirl ring 36 having distributions passages 36a for guiding plasma gas into a plasma chamber, thus into a space between the external surface of the distal end of the electrode 35 and the internal surface of the internal component 37 of the nozzle.

The nozzle is fixed so that the external component 38 abuts on the distal surface of the torch body 32 via the proximal surface of its radial protrusions 29, and the internal component 37 abuts on the swirl ring 36, wherein an accurate setting of the position is ensured by means of said radial protrusions 29. In the assembly, these radial protrusions 29 are held between the torch body 32 and the internal radial surface of a guiding part 30.

The assembly further comprises a directing component 1 which comprises a cylindrical portion 17 and a conical portion 18.

The external surface of the cylindrical portion 17 is provided with a first annular recess 14 arranged closer to the proximal end of the cylindrical portion 17. The purpose of the first annular recess 14 is to increase the heat extraction in a respective area via an increased amount of liquid that is present in the first annular recess 14 during cooling. The depth and the width of the first annular recess 14 may be selected according to desired degree of cooling in respective area and according to desired rigidity of the directing component 1 in the respective area.

The external surface is provided with a second annular recess 19 closer to the distal end of the cylindrical portion 17. The second annular recess 19 is provided with a first undercut groove 19a having a rounded bottom.

A sealing groove 19b is also arranged in the region between the first undercut groove 19a and the conical portion 18, said sealing groove 19b being intended for housing a sealing element 13. The sealing element 13 may be made of e.g. rubber and is preferably in the form of an O-ring.

A grooved region 20 is arranged between the first annular recess 14 and the second annular recess 19, wherein the linear grooves of the grooved region 20 extend in the longitudinal direction.

The internal surface of the cylindrical portion 17 is provided with a fastening recess 16a close to its proximal end, the fastening recess 16a being intended for allowing fastening of the directing component 1 to a suitable part of the torch, in this case to the guiding part 30. The fastening recess 16a thus comprises a radial retaining surface which faces the distal end, and with which it abuts on the adjacent proximal end surface of the guiding part 30, which is arranged in the directing component 1, when assembled.

The conical portion 18 tapers in the direction from the distal end of the cylindrical portion 17 to its distal end, wherein the cylindrical portion 17 and the conical portion 18 are mutually connected on the external side of the directing component via a radial annular surface. The distal end of the conical portion 18 is formed by a radial surface which is also the radial end surface of the directing component 1.

The conical portion 18 is provided with a second undercut groove 18a on the external side, wherein said second undercut groove 18a is annular and has a rounded bottom similarly to the first undercut groove 19a.

The internal surface of the conical portion 18 comprises a cylindrical section on its distal end, said cylindrical section being provided with an internal annular recess 18b which widens in the direction from its bottom. This internal annular recess 18b is intended to increase the surface of the cooled surface and to improve removal of the cooling liquid from the external surface of the nozzle. The proximal side of the internal annular recess 18b forms an angle with a plane perpendicular to the axis of the directing component 1, said angle being in the range of 10° to 60°, while the distal side forms an angle of 0° to 10° with this plane.

A cylindrical section adapted to abut on the first sealing ring 21 of the nozzle is located between the distal end of the directing component 1 and the internal annular recess 18b.

The internal surface of the conical portion 18 of the directing component 1 comprises a conical section at its proximal end, wherein a collar 16 protrudes from the internal surface of the conical portion 18 between the conical section and the cylindrical section. The collar 16 has an external surface (a surface facing away from the axis of the directing component 1), adapted for a sealing contact with an auxiliary sealer ring 31 for sealing of the contact between the ring 31 and the distal end of the guiding part 30 which is arranged inside the directing component 1.

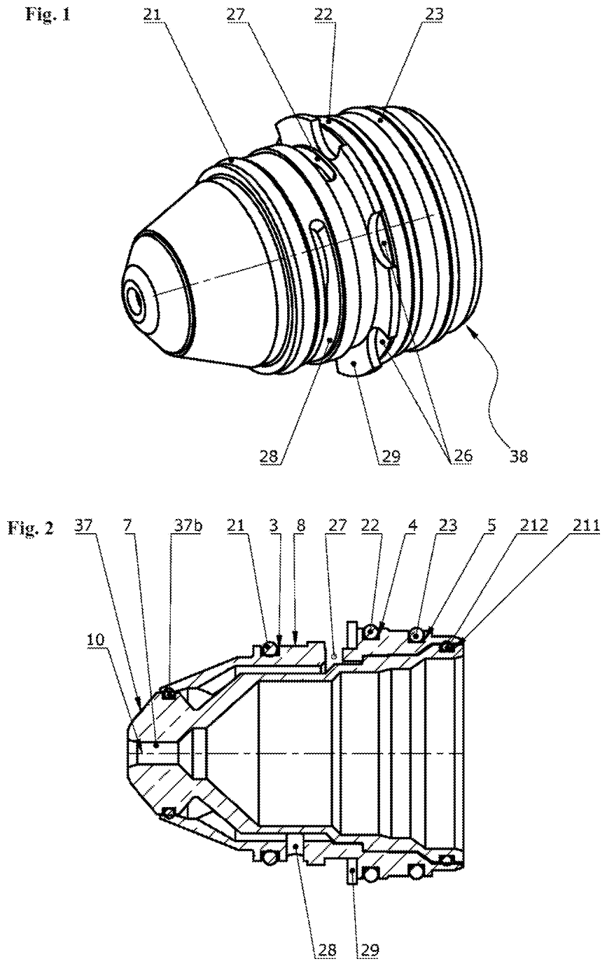

The directing component 1 is intended to direct and guide the cooling liquid and the shield gas inside the torch. The internal annular recess 18b, channels 11 for cooling liquid (see FIG. 2) and the external surface of the cylindrical portion of the directing component 1 are particularly intended to guide the cooling liquid. The channels 11 for cooling liquid extend through the conical portion 18 concurrently with the conical section of the internal surface of the conical portion 18, wherein their inlets are located in the bottom of the internal annular recess 18b and their outlet partially leads into the first undercut groove 19 on the external surface of the directing component 1.

The channels 11 for cooling liquid are spaced apart such that their axes lie on a conical surface and intersect in a point lying on the axis of the directing component 1. Therefore, they form an angle in the range of 30° to 60° with the axis of the directing component 1.

Channels 12 are intended for guiding the shield gas, wherein said channels 12 extend through the conical portion 18, wherein their inlets are located in the conical section of the internal surface of the conical portion 18 and their outlets are located on the external surface of the conical portion 18 and partially leads into the second undercut groove 18a.

The channels 12 for shield gas are spaced apart such that their axes lie on a conical surface and intersect in the point lying on the axis of the directing component 1. Therefore, they form an angle with the axis of the directing component 1 smaller than the angle formed by the axes of the channels 11 for cooling liquid, said angle being e.g. in the range of 10° to 30°.

Two to four, preferably three channels 11 for cooling liquid are always arranged and spaced apart between a pair of two neighboring channels 12 for shield gas.

The channels 11 for cooling liquid as well as the channels 12 for shield gas have a closed cross-section and preferably have a circular cross-section (and are thus circular in a cross-section perpendicular to their axis).

The directing component 1 is preferably made of an electrically insulating material.

The distal end of the nozzle is surrounded by a cap 48, the outlet opening of which is arranged coaxially with the outlet opening 7 of the nozzle. A spacer ring 49 is disposed between the cap 48 and the external component 38, said spacer ring 49 delimiting the mutual distance between the external surface of the external component 38 of the nozzle and the internal surface of the cap 48 and comprising radial passages 49a for shield gas.

The cap 48 together with the spacer ring 49 are fixed by means of a holding part 40 to the torch.

While the torch is in operation, the plasma gas flows through the distribution passages 36a of the swirl ring 36 into a plasma chamber defined between the internal surface of the internal component 37 of the nozzle and the distal end of the electrode 35, and further together with the plasma arc out through the outlet opening of the nozzle and the outlet opening of the cap 48. At the same time, shield gas is fed through an opening in the guiding part 30 into the space between the internal surface of the cylindrical portion 17 and the concurrently extending external surface of the guiding part 30. The shield gas is further guided through the channels 12 for shield gas from a region adjacent to the internal surface of the conical portion 18 to the region adjacent to its external surface and further through the radial passages 49a of the spacer ring 49 and along the internal surface of the cap 48 (and the external surface of the nozzle) to the outlet opening of the cap 48.

The cooling liquid is simultaneously being fed into the torch. The cooling liquid is fed into the space between the torch body 32 and the internal surface of the guiding part 30 and further through an inlet passage 38b of the external component 38 of the nozzle into the cooling space between the internal surface of the external component 38 and the external surface of the internal component 37 of the nozzle. The cooling liquid is subsequently lead away through the outlet passage of the external component 38 into the internal annular recess 18b, wherein it further passes through the directing component 1, specifically through the channels 11 for cooling liquid, and reaches the space between the internal surface of the holding part 40 and the external surface of the cylindrical portion 17 of the directing component 1, it is further guided in the proximal direction and lead away from the torch thereafter.

In the embodiments of FIGS. 3 and 4, the cooling liquid does not reach the space between the external component 138 and the internal component 137 but only the external surface of the external component 138, where it intensively cools the intermediary region 108. The cooling is intensive thanks to its shape—the intermediary region 108 has a relatively large surface and at the same time provides a relatively large space for the cooling liquid, thereby allowing for a presence of a relatively large amount of the cooling liquid.

Both in the nozzle of FIGS. 1 and 2 and the nozzle of FIGS. 3 and 4, the electric potential for the ignition of the plasma arc is lead to the external component 38, 138 and from it to the internal component 37, 137, wherein the plasma arc is then ignited between the internal surface of the distal end of the internal component 37, 137 (in other words in the vicinity of the outlet opening 7, 107) and the distal end of the electrode 35.

As used herein, the expression proximal presents a portion or a surface, which is closer to the power source when considering the electrical current path (i.e. more distant from the workpiece to be processed), and the expression distal presents a portion or a surface, which is closer to the workpiece to be processed when considering the electrical current path (i.e. further from the power source).

It is clear that a person skilled in the art would readily find further possible alternatives to the embodiments described herein. The scope of the protection is therefore not limited to these exemplifying embodiments but it is rather defined by the appended patent claims.

1. Nozzle for a plasma cutting and welding torch, said nozzle comprising:
an internal component which defines an internal pass-through cavity to form a plasma chamber having an outlet opening,
an external component which at least partially and coaxially surrounds the internal component and which has a distal conical region, a proximal cylindrical region and an intermediary region between those,
wherein radial protrusions are arranged with a mutual angular spacing at an external surface of the external component along a common radial plane between the intermediary region and the proximal cylindrical region.

2. Nozzle according to claim 1, wherein in an area where the radial protrusions are adjacent to the proximal cylindrical region, the proximal cylindrical region of the external component has a larger diameter than the intermediary region in the area adjacent to the radial protrusions.

3. Nozzle according to claim 1, wherein the radial protrusions overreach in the radial direction the other parts of the nozzle.

4. Nozzle according to claim 1, wherein the radial protrusions have proximal radial surfaces which are arranged in a common radial plane and/or have distal radial surfaces which are arranged in a common radial plane.

5. Nozzle according to claim 1 wherein
the external surface of the external component is, between the distal conical region and the intermediary region, provided with a first annular groove for a first sealing ring and/or
the proximal cylindrical region of the external component is provided with a second annular groove for a second sealing ring.

6. Nozzle according to claim 1, wherein an internal surface of the external component abuts on an external surface of the internal component via a second sealer ring, wherein the external component is, in the intermediary region, provided with a coolant inlet in the form of a through slot or a pass-through opening or openings, and a coolant outlet in the form of a through slot or a pass-through opening or openings for feeding and leading away of the coolant to and from the space between the internal component and the external component.

7. Nozzle according claim 1, wherein a vent space is located between the external surface of the internal component and the internal surface of the external component, wherein the inlet of said vent space is defined between the internal surface of the external component and the external surface of the distal end of the internal component and the outlet is formed by a pass-through vent opening in the wall of the external component.

8. Plasma torch comprising:
a torch body,
an electrode, attached to the torch body,
a nozzle which coaxially surrounds a distal end of the electrode,
a cap which coaxially surrounds a distal end of the nozzle,
a guiding part which coaxially surrounds a part of the torch body and a part of the nozzle, and
a directing component, which coaxially surrounds the guiding part, wherein channels for cooling liquid and channels for shield gas are arranged in its distal conical portion,
wherein the nozzle is a nozzle according to claim 1.

9. Plasma torch according to claim 8, wherein the radial protrusions are held between a distal end surface of the torch body and the internal surface of the guiding part and/or directing component.

10. Plasma torch according to claim 8, wherein spaces between the radial protrusions on the external surface of the external component form passages for feeding of the cooling liquid into the coolant inlet in the intermediary region, or the spaces between the radial protrusions on the external surface of the external component form passages for feeding of the cooling liquid onto the intermediary region.
